(19) United States
(12) Patent Application Publication
(10) Pub. No.: US 2016/0189043 A1
(43) Pub. Date: Jun. 30, 2016

(54) CRIME FORCASTING SYSTEM

(71) Applicant: Locator IP, L.P., State College, PA (US)

(72) Inventors: Casey MCGEEVER, State College, PA (US); Ethan KNOCKE, Port Matilda, PA (US); Rosemary Yeilding RADICH, Maize, KS (US)

(21) Appl. No.: 14/979,434

(22) Filed: Dec. 27, 2015

Related U.S. Application Data
(60) Provisional application No. 62/096,631, filed on Dec. 24, 2014.

(51) Int. Cl. G06N 5/04

(52) U.S. Cl. CPC G06N 5/04

(57) ABSTRACT

A crime forecasting system and method that stores crime data and weather data and determines a crime forecast by adjusting an historical crime rate based on a correlation between a forecasted weather condition and the crime data. The crime forecasting system and method may further store event data and determine the crime forecast by further adjusting the historical crime rate based on a correlation between a future event and the crime data.

### CROSS REFERENCE TO RELATED APPLICATION

This application claims priority to U.S. Provisional Patent Application No. 62/096,631, filed Dec. 24, 2014, the entire contents of which are hereby incorporated by reference.

### BACKGROUND

Current crime analysis systems can provide law enforcement agencies with historical crime data, thereby enabling law enforcement officers to deploy resources based on past criminal activity. Current crime analysis systems, however, do not determine correlations between past crimes and weather conditions (or previous events) and provide crime forecasts based on real-time data such as forecasted weather conditions (or future events).

Current crime statistics provide individuals and business owners with a general idea of whether neighborhoods are relatively safe or unsafe. Again, however, individuals and business owners do not have access to crime forecasts determined based on correlations between past crime statistics and real-time data such as forecasted weather conditions (or future events).

Accordingly, there is a need for a crime forecasting system and method that enables law enforcement agencies to accurately and effectively deploy resources, enables individuals to increase situational awareness and select a safe travel route, and allows business owners to anticipate the risk of crime at a business location.

### SUMMARY

In order to overcome these and other disadvantages in the related art, there is provided a crime forecasting system and method that stores crime data and weather data and determines a crime forecast by adjusting an historical crime rate based on a correlation between a forecasted weather condition and the crime data. The crime forecasting system and method may further store event data and determine the crime forecast by further adjusting the historical crime rate based on a correlation between a future event and the crime data.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a drawing illustrating a points of interest view of a graphical user interface output by a crime forecasting system according to an exemplary embodiment of the present invention;

FIG. 2 is an overview of the crime forecasting system according to an exemplary embodiment of the present invention;

FIG. 3 is a block diagram of the crime forecasting system illustrated in FIG. 2 according to an exemplary embodiment of the present invention;

FIG. 4 is a drawing illustrating a street level view of the graphical user interface output by the crime forecasting system according to an exemplary embodiment of the present invention;

FIGS. 5A and 5B are drawings illustrating neighborhood views of the graphical user interface output by the crime forecasting system according to an exemplary embodiment of the present invention;

FIG. 6 is a drawing illustrating a travel route view of the graphical user interface output by the crime forecasting system according to an exemplary embodiment of the present invention;

FIG. 7 is a drawing illustrating a crime alert module and query alert module output by the crime forecasting system via the graphical user interface according to an exemplary embodiment of the present invention;

FIG. 8 is a drawing illustrating an hourly crime index module and a daily crime index module output by the crime forecasting system via the graphical user interface according to an exemplary embodiment of the present invention;

FIG. 9 is a drawing illustrating MinuteCast® modules output by the crime forecasting system via the graphical user interface according to an exemplary embodiment of the present invention; and

FIG. 10 is a flow chart illustrating a process for outputting crime forecasts according to an exemplary embodiment of the present invention.

### DETAILED DESCRIPTION OF THE INVENTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

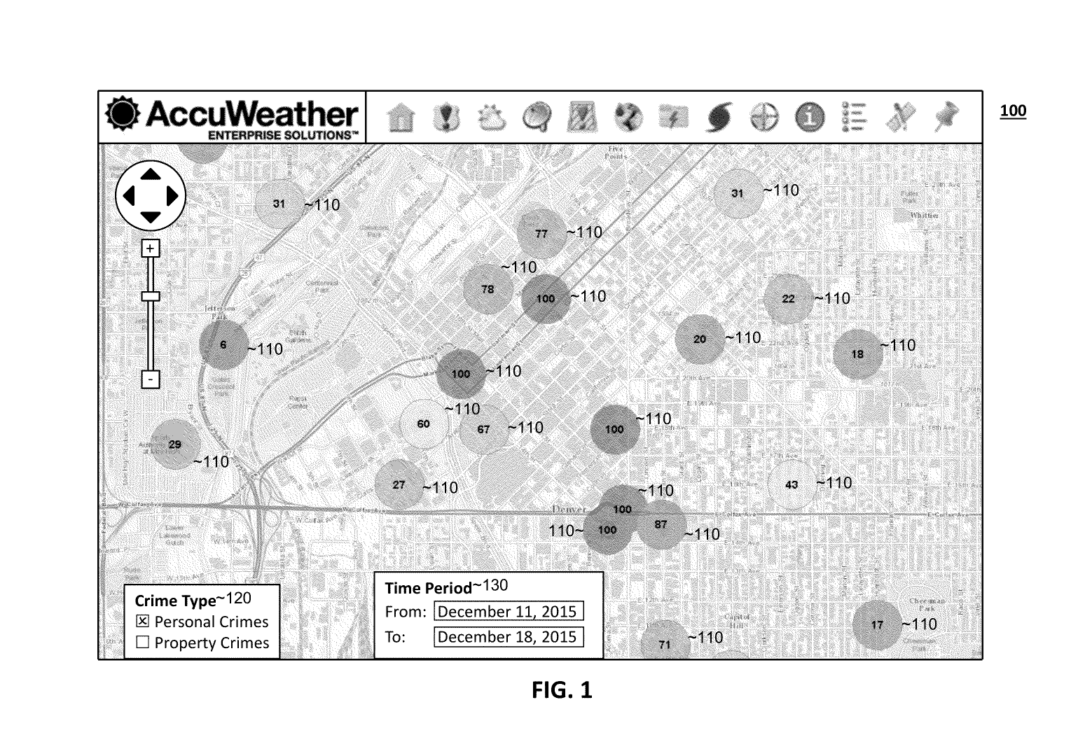

FIG. 1 illustrates a points of interest view 100 of a graphical user interface (GUI) output by a crime forecasting system 200 according to an exemplary embodiment of the present invention. As described below, the crime forecasting system 200 may output a crime forecast for a plurality of user-identified locations 110 (in this example, points of interest in and around Denver).

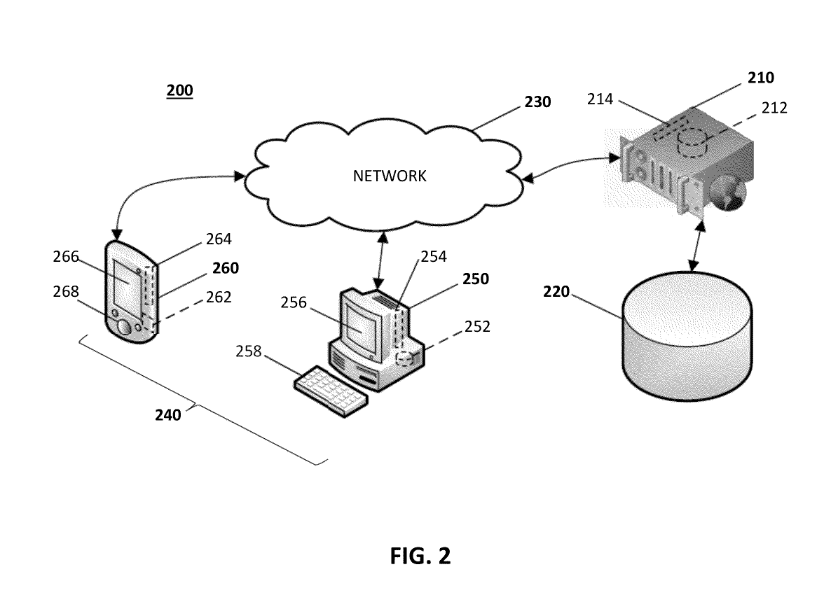

FIG. 2 illustrates an overview of the crime forecasting system 200. The crime forecasting system 200 may include one or more servers 210 and one or more databases 220 connected to a plurality of remote computer systems 240, such as one or more personal systems 250 and one or more mobile computer systems 260, via one or more networks 230.

The one or more servers 210 may include an internal storage device 212 and a processor 214. The one or more servers 210 may be any suitable computing device including, for example, an application server and a web server which hosts websites accessible by the remote computer systems 240. The one or more databases 220 may be internal to the server 210, in which case they may be stored on the internal storage device 212, or they may be external to the server 212, in which case they may be stored on an external non-transitory computer-readable storage medium, such as an external hard disk array or solid-state memory. The one or more databases 220 may be stored on a single device or multiple devices. The networks 230 may include any combination of the internet, cellular networks, wide area networks (WAN), local area networks (LAN), etc. Communication via the networks 230 may be realized by wired and/or wireless connections. A remote computer system 240 may be any suitable electronic device configured to send and/or receive data via the networks 230. A remote computer system 240 may be, for example, a network-connected computing device such as a personal computer, a notebook computer, a smartphone, a personal digital assistant (PDA), a tablet, a notebook computer, a portable weather detector, a global positioning satellite (GPS) receiver, network-connected vehicle, etc. A personal computer systems 250 may include an internal storage device 252, a processor 254, output devices 256 and input devices 258. The one or more mobile computer systems 260 may include an internal storage device 262, a processor 264, output devices 266 and input devices 268. An internal storage device 212, 252, and/or 262 may be non-transitory computer-readable storage mediums, such as hard disks or solid-state memory, for storing software instructions that, when executed by a processor 214, 254, or 264, carry out relevant portions of the features described herein. A processor 214, 254, and/or 264 may include a central processing unit (CPU), a graphics processing unit (GPU), etc. A processor 214, 254, and 264 may be realized as a single semiconductor chip or more than one chip. An output device 256 and/or 266 may include a display, speakers, external ports, etc. A display may be any suitable device configured to output visible light, such as a liquid crystal display (LCD), a light emitting polymer displays (LPD), a light emitting diode (LED), an organic light emitting diode (OLED), etc. The input devices 258 and/or 268 may include keyboards, mice, trackballs, still or video cameras, touchpads, etc. A touchpad may be overlaid or integrated with a display to form a touch-sensitive display or touchscreen.

The crime forecasting system 200 may be realized by software instructions stored on one or more of the internal storage devices 212, 252, and/or 262 executed by one or more of the processors 214, 254, or 264.

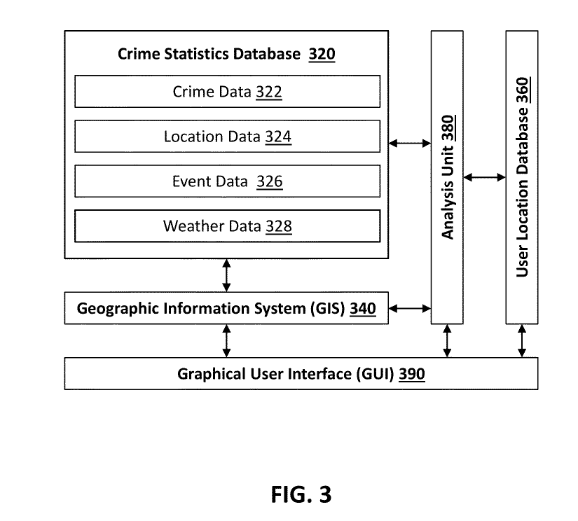

FIG. 3 is a block diagram of the crime forecasting system 200 according to an exemplary embodiment of the present invention. The crime forecasting system 200 may include a crime statistics database 320, a geographic information system (GIS) 340, a user location database 360, an analysis unit 380, and a graphical user interface (GUI) 390.

The crime statistics database 320 stores crime data 322. In some embodiments, the crime statistics database 320 also stores location data 324, event data 326, and/or weather data 328. The crime statistics database 320 may be any organized collection of information, whether stored on a single tangible device or multiple tangible devices. The crime statistics database 320 may be realized, for example, as one of the databases 220 illustrated in FIG. 2.

The crime data 322 may include information indicative of the location, time, date, day of the week, type (e.g., assault, burglary, robbery, etc.) of crimes. The crime data 322 may also include an estimate of the severity of each crime. The crime locations may be in a format such that the locations of each crime may be viewed and analyzed by the GIS 340. The crime type may also include whether the crime was a property crime, an offense against a person, etc. For property crime, the crime data 322 may also include information regarding the property (for example, whether the property was a business, a residence, a vehicle, etc.) For each offense against a person, the crime data 322 may also include whether the victim knew the assailant or whether the assailant was a stranger. The crime data 322 may also include demographic information regarding the victim, such as age, sex, race, Hispanic origin, economic status, etc. The crime data 322 may be updated either via the GUI 390 or by importing additional crime data from another source.

The location data 324 may include information such as demographic data, law enforcement boundaries, the locations of community institutions (e.g., police station, fire stations, schools, churches, hospitals, etc.), the locations of businesses, etc. The demographic data may be in the form of tapestry segmentation, which classifies residential areas as one of 67 distinctive segments based on the socioeconomic and demographic composition of the residential area. Those segments may be grouped based on common experiences (e.g., born in the same generation, immigration from another country) or demographic traits. Those segments may also be grouped based on geographic density (e.g., principal urban centers, urban periphery, metro cities, suburban periphery, semirural, rural). The location data 324 may be updated either via the GUI 390 or by importing additional location data from another source.

The event data 326 stores locations, dates, and times of past events such as sporting events, concerts, parades, etc. The events may also include government transfer payments. The event data 326 may also include the locations, dates and times of future events. The event data 326 may be updated either via the GUI 390 or by importing additional event data from another source.

The weather data 328 includes information regarding current, historical (past), and forecasted (future) weather conditions. The weather data 328 may be received, for example, from AccuWeather, Inc., AccuWeather Enterprise Solutions, Inc., governmental agencies (such as the National Weather Service (NWS), the National Hurricane Center (NHC), Environment Canada, the U.K. Meteorologic Service, the Japan Meteorological Agency, etc.), other private companies (such as Vaisalia's U.S. National Lightning Detection Network, Weather Decision Technologies, Inc.), individuals (such as members of the Spotter Network), etc. The weather information database may also include information regarding natural hazards (such as earthquakes) received from, for example, the U.S. Geological Survey (USGS).

Weather conditions may include, for example, the 24-hr maximum temperature, the 24-hr minimum temperature, the air quality, the amount of ice, the amount of rain, the amount of snow falling, the amount of snow on the ground, the Arctic Oscillation (AO), the average relative humidity, the barometric pressure trend, the blowing snow potential, the ceiling, the ceiling height, the chance of a thunderstorm, the chance of enough snow to coat the ground, the chance of enough snow to wet a field, the chance of hail, the chance of ice, the chance of precipitation, the chance of rain, the chance of snow, the cloud cover, the cloud cover percentage, the cooling degrees, the day sky condition, the day wind direction, the day wind gusts, the day wind speed, the dew point, the El Nino Southern Oscillation (ENSO), the evapotranspiration, the expected thunderstorm intensity level, the flooding potential, the heat index, the heating degrees, the high temperature, the high tide warning, the high wet bulb temperature, the highest relative humidity, the hours of ice, the hours of precipitation, the hours of rain, the hours of snow, the humidity, the lake levels, the liquid equivalent precipitation amount, the low temperature, the low wet bulb temperature, the maximum ultraviolet (UV) index, the Multivariate ENSO Index (MEI), the Madden-Julian Oscillation (MJO), the moon phase, the moonrise, the moonset, the night sky condition, the night wind direction, the night wind gusts, the night wind speed, the normal low temperature, the normal temperature, the one-word weather, the precipitation amount, the precipitation accumulation, the precipitation type, the probability of snow, the probability of enough ice to coat the ground, the probability of enough snow to coat the ground, the probability of enough rain to wet a field, the rain amount, the RealFeel®, the RealFeel® high, the RealFeel® low (REALFEEL is a registered service mark of AccuWeather, Inc.), the record low temperature, the record high temperature, the relative humidity range, the sea level barometric pressure, the sea surface temperature, the sky condition, the snow accumulation in the next 24 hours, the solar radiation, the station barometric pressure, the sunrise, the sunset, the temperature, the type of snow, the UV index, the visibility, the wet bulb temperature, the wind chill, the wind direction, the wind gusts, the wind speed, etc. The weather conditions may include weather-related warnings such as river flood warnings, thunderstorm watch boxes, tornado watch boxes, mesoscale discussions, polygon warnings, zone/country warnings, outlooks, advisories, watches, special weather statements, lightning warnings, thunderstorm warnings, heavy rain warnings, high wind warnings, high or low temperature warnings, local storm reports, earthquakes, and/or hurricane impact forecasts. Each weather condition may be expressed based on a time frame, such as the daily value, the hourly forecast value, the daily forecast value, the daily value one year ago, the accumulation or variations over a previous time period (e.g., 24 hours, 3 hours, 6 hours, 9 hours, the previous day, the past seven days, the current month to date, the current year to date, the past 12 months), the climatological normal (e.g., the average value over the past 10 years, 20 years, 25 years, 30 years, etc.), the forecasted accumulation over a future time period (e.g., 24 hours), etc.

The geographic information system (GIS) 340 is a software system designed to capture, store, manipulate, analyze, manage, and present geographical data. (Geographic information systems are sometimes referred to as geographical information systems.) The GIS 340 may be realized as software instructions executed by the one or more servers 210 illustrated in FIG. 2. Additionally or alternatively, the crime forecasting system 200 may use a third party GIS such as Google maps, Ersi, etc.

The user location database 360 stores information indicative of the locations of remote computer systems 240 (or users). The location of a user or remote computer system 240 may be static (i.e., if the user or remote computer system 240 is stationary) or dynamic (i.e., if the user or remote computer system 240 is in motion). In some instances, the user location database 360 may store information indicative of the real-time (or near real-time) dynamic location of a remote computer system 240. Additionally, the user location database 360 may be automatically and/or repeatedly updated to include information indicative of the real-time (or near real-time) dynamic location of a remote computer system 240.

The (static or dynamic) location of a remote computer system 240 may be determined by the remote computer system 240, for example, by a global positioning satellite (GPS) device incorporated within the remote computer system 240, cell network triangulation, network identification, etc. Additionally or alternatively, the (static or dynamic) location of a remote computer system 240 may be determined by the server 210, for example, by cell network triangulation, network identification, etc. A static location of a user may be input by the user, for example by inputting a location such as an address, a city, a zip code, etc. via the GUI 390. A dynamic location of a user may input by the user, for example by inputting a destination and causing a remote computer system 240 or a server 210 to determine a route of travel to the destination from a starting point or current location. The user location database 360 may be any organized collection of information, whether stored on a single tangible device or multiple tangible devices. The user location database 360 may be realized, for example, as one of the databases 220.

The analysis unit 380 may be realized by software instructions accessible to and executed by the one or more servers 210 and/or downloaded and executed by the remote computer systems 240. The analysis unit 380 may be configured to receive information from the crime statistics database 320, the GIS 340, the user location database 360, and the GUI 390.

The graphical user interface 390 may be any interface that allows a user to input information for transmittal to the crime forecasting system 200 and/or any interface that outputs information received from the crime forecasting system 200 to a user. The graphical user interface 390 may be realized by software instructions stored on and executed by a remote computer system 240.

The analysis unit 380 uses the GIS 340 to plot the locations and times of each of the crimes in the crime data 322. The analysis unit 380 determines whether the crime data 322 correlates to one or more variables in the location data 324. For example, the analysis unit 380 determines whether the crimes (or certain types of crimes) are correlated with neighborhood demographics, law enforcement boundaries, and/or proximity to community institutions or businesses. If the demographic data includes tapestry segmentation, which classifies and groups similar residential areas, the analysis unit 380 determines whether similar residential areas have experienced similar numbers of and/or types of crimes.

The analysis unit 380 also determines whether the crime data 322 correlates with one or more variables in the event data 326. For example, the analysis unit 380 may determine that crimes (or certain types of crimes) included in the crime data 322 are linearly correlated with a certain type of event by a factor of 1.25 (meaning that, proximate that type of event, a crime or type of crime is 25 percent more likely).

The analysis unit 380 also determines whether the crime data 322 correlates the one or more variables in the weather data 326. For example, the analysis unit 380 may determine that crimes (or certain types of crimes) included in the crime data 322 are linearly correlated with Blizzard-like conditions by a factor of 0.0002 while crimes (or certain types of crimes) are linearly correlated with a RealFeel® temperature above 95 degrees Fahrenheit by a factor of 1.4 (meaning that crimes are highly unlikely during a Blizzard, but 40 percent more likely than normal in the heat).

Based on the correlations discussed above, the analysis unit 380 determines the likelihood of a crime occurring at a specific location or in a demographically similar location, at a particular time of day, on a particular day of the week, in a particular season of the year, and/or proximate a particular community institution or particular type of business. Based on past crimes against individuals, the analysis unit 380 may determine the likelihood of a crime occurring against any individual, against an individual that does not know the perpetrator, and/or against an individual of a specific demographic group. Based on past property crimes, the analysis unit 380 may determine the likelihood of a crime occurring in a vehicle, at a property, at a residence, at a business, and/or at a specific type of business.

The analysis unit 380 may also determine the likelihood of a crime (or a certain type of crime) occurring with a proximity of a future event included in the event data 326 based on the correlation of past crimes (or a certain type of crime) with past events included in the event data 326.

The analysis unit 380 may also determine the likelihood of a crime (or a certain type of crime) occurring in a forecasted weather condition included in the weather data 328 based on the correlation of past crimes (or a certain type of crime) with past weather conditions included in the weather data 328.

The crime data 322 may be updated over time. Similarly, the location data 324, the event data 326, and/or the weather data 328 may also be updated. Accordingly, the analysis unit 380 may determine whether the (updated) crime data 322 correlates with the (potentially updated) location data 324, the (potentially updated) event data 326, and/or the (potentially updated) weather data 328.

The crime data 322 may include crime information from official sources. Additionally, the crime data 322 may include (raw or analyzed) crime information derived from the Internet, social media (e.g., Facebook, Twitter, etc.), internet searches (e.g., Google, Bing, Aliaba, etc.), facial recognition systems, etc. The locations of crimes derived from the (raw or analyzed) crime information may be derived from the locations of the users that uploaded/posted the crime information or from the crime information. The times of the crimes derived from the (raw or analyzed) crime information may be derived from the time the crime information was uploaded/posted or from the information.

The crime data 322 may include information regarding whether the reported crime resulted in a conviction. The analysis unit 380 can then be used to compare the effectiveness of law enforcement across jurisdictions. The crime data 322 may also include information regarding whether the reported crime was determined to be a false report. The analysis unit 380 can then be used to analyze false crime reports.

The crime forecasting system 200 outputs a “crime forecast.” As used herein, a “crime forecast” may refer to information indicative of the likelihood of a crime occurring as determined above. The crime forecast may be expressed by the crime forecasting system 200 as a percentage chance of a crime occurring, a difference between the percentage chance of a crime occurring and a baseline (e.g., the percentage chance of a crime occurring in a larger geographic area), a scalar value (e.g., 0-100) or category (e.g., A-F or Green-Red) selected based on the percentage change of a crime occurring or a difference between the percentage chance of a crime occurring and a baseline.

Referring back to FIG. 1, the crime forecasting system 200 may output crime forecasts for a plurality of user-identified locations 110 (in this example, points of interest in and around Denver) in a points of interest view 100. The GUI 390 may plot the crime forecasts on a map using the GIS 340. The GUI 390 may enable users to specify the crime types (for example, using the crime type box 120) and/or a time period (for example, using the time period box 130) for the crime forecasts. The analysis unit 380 calculates the likelihood that one of the user-specified crimes will occur in each of the user-identified location over the user-specified time period and outputs the crime forecast for each of the user-identified locations via the GUI 390.

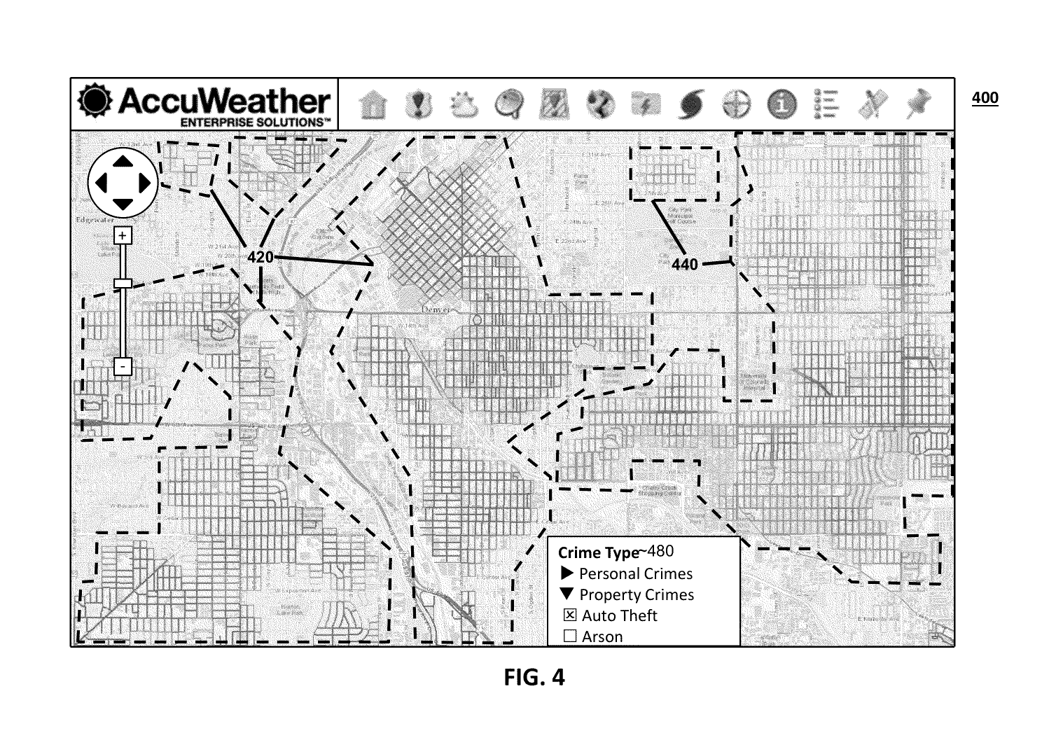

FIG. 4 illustrates a street level view 400 of the graphical user interface 390 output by a crime forecasting system 200 according to an exemplary embodiment of the present invention. In FIG. 4, each of the streets in the dashed boxes 420 are shaded various shades of red (indicating an elevated crime forecast relative to a baseline) and each of the streets in the dashed boxes 440 are shaded various shades of blue (indicating a lower crime forecast relative to a baseline). Again, the GUI 390 may enable users to specify the crime types (for example, using the crime type box 480) and/or a time period for the crime forecast. The baseline may be the crime forecast for a larger geographic area (such as the greater metropolitan region or state or nation). The analysis unit 380 calculates the likelihood that the crime(s) specified by the user will occur on each of the streets of the street level view 400 relative to the baseline (e.g., the national average) and colors each of the streets of the street level view 400 according to the crime forecast.

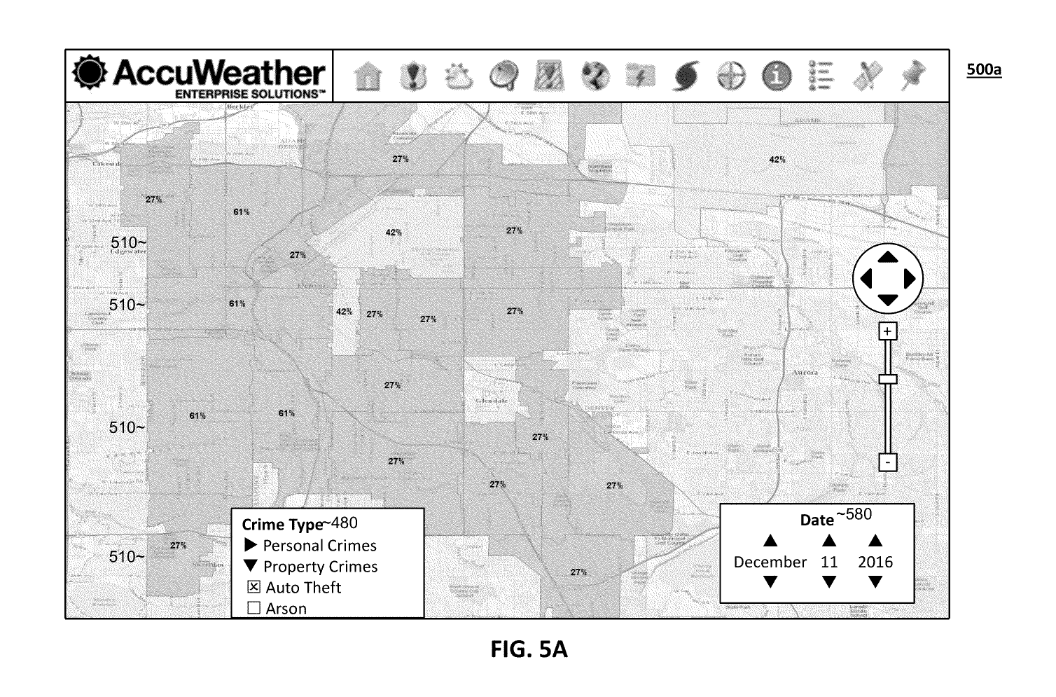

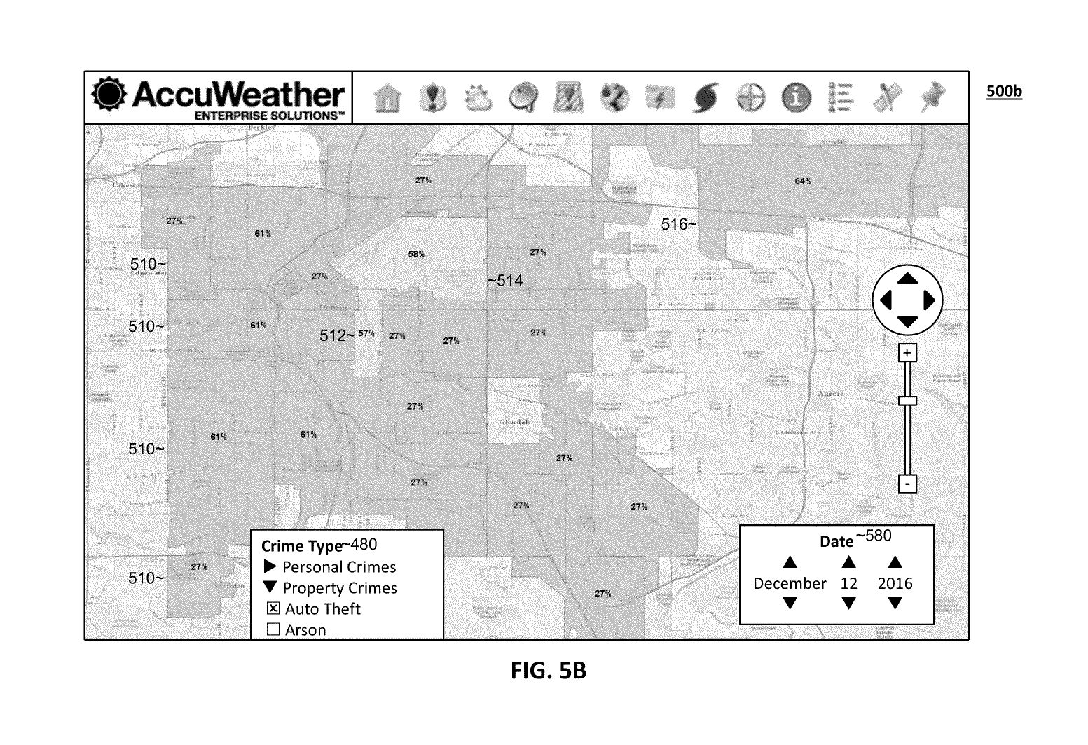

FIGS. 5A and 5B illustrate neighborhood views 500a and 500b of the graphical user interface 390 output by a crime forecasting system 200 according to an exemplary embodiment of the present invention.

As shown in FIG. 5B, the crime forecasting system 200 may output crime forecasts for a plurality of neighborhoods 510. Again, the GUI 390 may plot the crime forecasts on a map using the GIS 340. Again, the GUI 390 may enable users to specify the crime types (for example, using the crime type box 480) and/or a time period (for example, using the date box 580) for the crime forecasts. The analysis unit 380 calculates the likelihood that one of the user-specified crimes will occur in each of the neighborhoods 510 over the user-specified time period and outputs the crime forecast for each of the neighborhoods 510 via the GUI 390. Referring to FIG. 5B, the crime forecast may increase from the first date (Dec. 11, 2016) to the second date (Dec. 12, 2016) as shown in neighborhoods 512, 514, and 516.

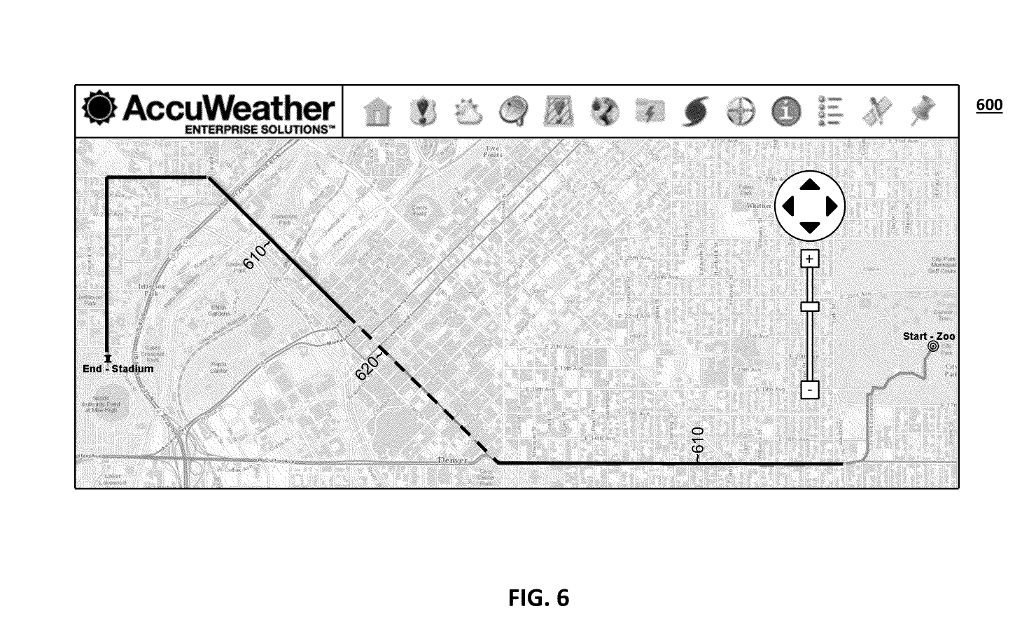

FIG. 6 illustrates a travel route view 600 of the graphical user interface 390 output by an crime forecasting system 200 according to an exemplary embodiment of the present invention. In FIG. 6, the solid lines 610 are green in color (indicating a low crime forecast) and the dashed line 620 is shaded yellow and red (indicating mid-level and high crime forecasts).

As shown in FIG. 6, the crime forecasting system 200 may output a crime forecast for each point along a travel route. Again, the GUI 390 may enable users to specify the crime type and/or a time period for the crime forecasts. Because the travel route view 600 is intended to assist travelers, the crime forecasting system 200 may be preset to output a crime forecast for crimes that are relevant to travelers such as personal crimes where the victim does not know the perpetrator, auto theft, etc.

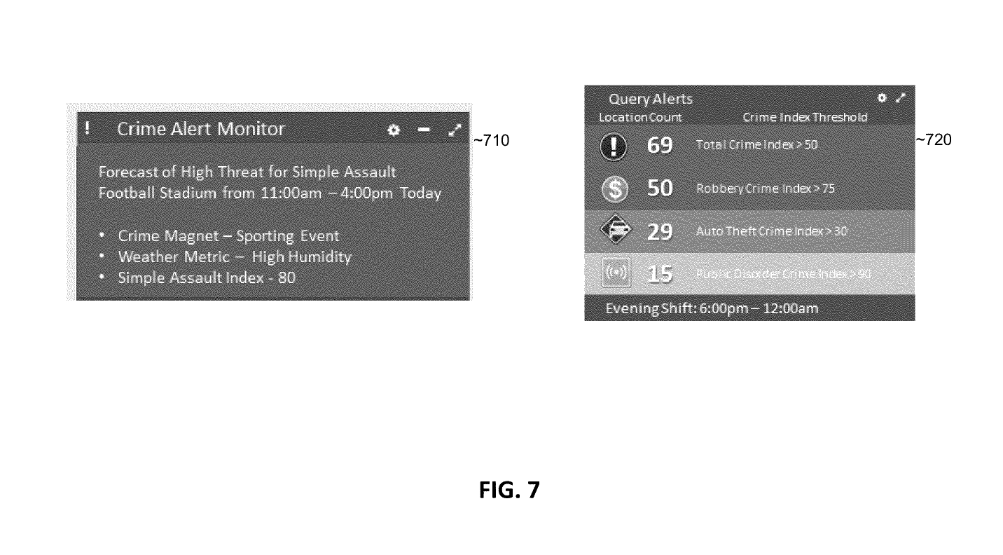

FIGS. 7 through 10 illustrate modules output by the crime forecasting system 200 via the GUI 390. The crime forecasting system 200 may be incorporated with the customizable weather analysis system described in PCT Application No. PCT/US14/55004, which is incorporated herein by reference in its entirety.

FIG. 7 illustrates a crime alert module 710 and query alert module 720 output by the crime forecasting system 200 via the GUI 390 according to an exemplary embodiment of the present invention.

As illustrated by the crime alert module 710, the crime forecasting system 200 may output an alert when the crime forecast exceeds an alert threshold. The crime forecasting system 200 may enable a user to identify one or more locations, crimes, crime types, time periods, and/or the alert threshold. The analysis unit 380 calculates the likelihood that a crime (or a user-specified crime or a crime belonging to a user-specified crime type) will occur in each of the user-identified locations over the user-specified time period and outputs a crime alert (as shown, for example, in the crime alert module 710) if the crime forecast exceeds the (predetermined or user-specified) alert threshold in a user-identified location.

In another embodiment, the crime forecasting system 200 may output a crime alert to a remote computer system 240 if the crime forecast for the location of the remote computer system 240 exceeds a (predetermined or user-specified) alert threshold. The location of the remote computer system 240 may be determined by the remote computer system 240 or the server 210 and stored in the user location database 360. In this embodiment, the analysis unit 380 calculates the likelihood that a crime (or a user-specified crime or a crime belonging to a user-specified crime type) will occur at the location of the remote computer system 240 and outputs a crime alert if the crime forecast exceeds the (predetermined or user-specified) alert threshold. In this embodiment, the crime forecasting system 200 may be preset to determine the crime forecast for crimes that are relevant to individuals (e.g., personal crimes where the victim does not know the perpetrator).

In another embodiment, the crime forecasting system 200 may output a crime forecast to a mobile computer system 260 for the location of the mobile computer system 260. The crime forecast may be expressed as a scale (e.g., 0-100 or green-yellow-red) indicating the crime forecast or the crime forecast relative to a baseline. The baseline may be a previous location of the mobile computer system 260.

As illustrated by the query alert module 720, the crime forecasting system 200 may allow users to receive crime forecasts based on a user-specified query. The user-specified query may include one or more crime types, a plurality of user-identified locations, and a user-specified time-period. The query alert module 720 indicates that, from 6 pm to 12 am, 69 of the user-identified locations have a crime forecast for all crimes (“Total Crime Index”) above 50; 50 of the user-identified locations have a crime forecast for robbery above 75; 29 of the user-identified locations have a crime forecast for auto theft above 30; and 15 of the user-identified locations have a crime forecast for public disorder.

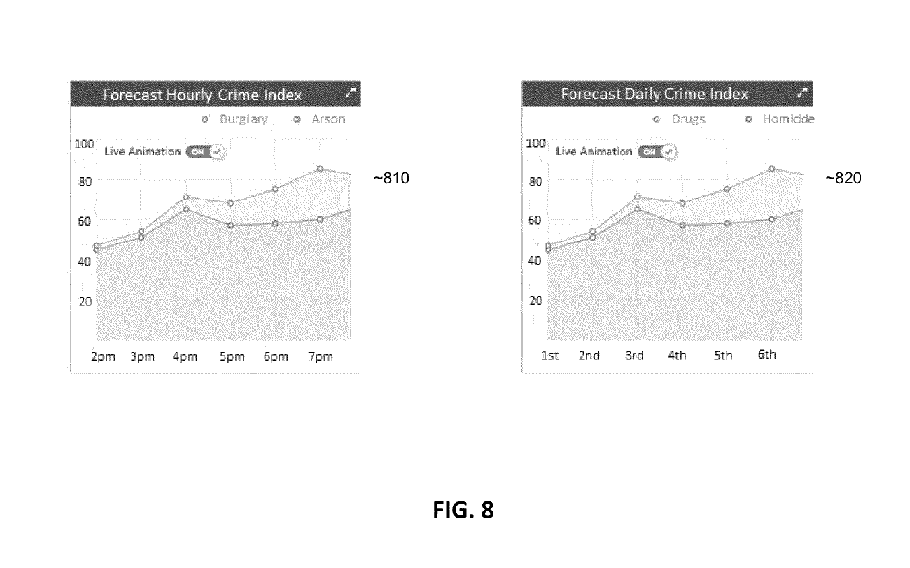

FIG. 8 illustrates an hourly crime index module 810 and a daily crime index module 820 output by the crime forecasting system 200 via the GUI 390 according to an exemplary embodiment of the present invention.

The hourly crime index module 810 shows line graphs of the hourly crime forecasts for a user-identified location (in this instance, the crime forecasts for burglary and arson). The daily crime index module 820 shows line graphs of the daily crime forecasts for a user-identified location (in this instance, the crime forecasts for drug crimes and homicide).

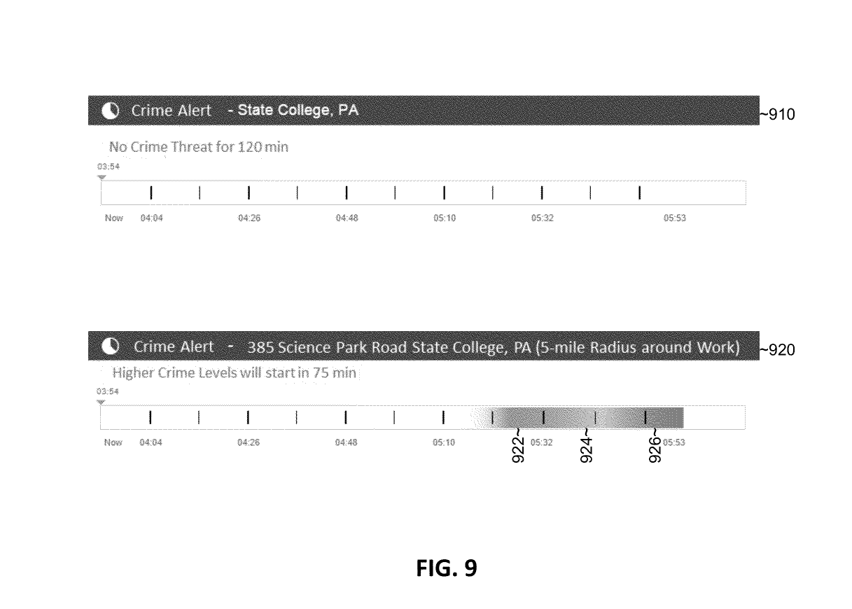

FIG. 9 illustrate MinuteCast® modules 910 and 920 output by the crime forecasting system 200 via the GUI 390 according to an exemplary embodiment of the present invention. A MinuteCast® is a hyper-local, minute-by-minute forecast over a short time period such as 120 minutes. (MINUTECAST is a registered service mark of AccuWeather, Inc.) The MinuteCast® module 910 indicates that there is no crime threat, meaning the crime forecast is below a threshold, for 120 minutes. The MinuteCast® module 910 indicates that higher levels of crime are forecasted in 75 minutes. The timeline shows a green area 922, indicating a higher crime forecast, a yellow area 924, indicating an even higher crime forecast, and a red area 926, indicating an even higher crime forecast.

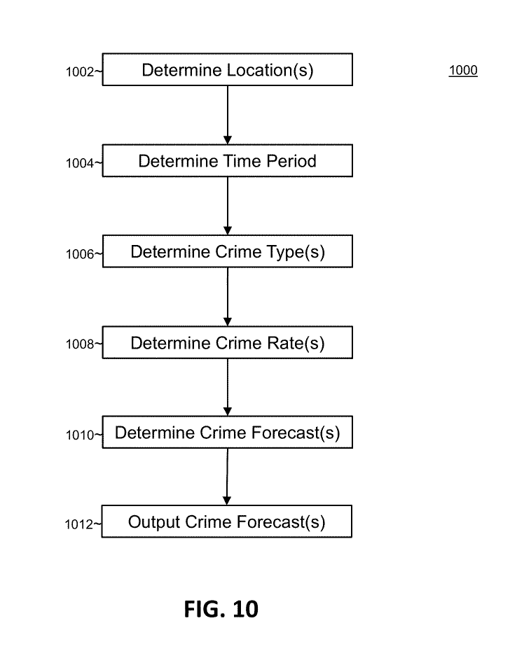

FIG. 10 illustrates a process 1000 for outputting crime forecasts according to an exemplary embodiment of the present invention.

One or more locations are determined in step 1002. Each location may be a single point (e.g., an address, intersection, longitude and latitude, etc.) or larger geographic area (e.g., a neighborhood, political subdivision, law enforcement jurisdiction, etc.). The locations(s) may be input by the user, determined based on the location of a mobile computer system 260, determined based on a route of travel, etc. If the crime forecasting system 200 is outputting a map (as shown, for example, in the neighborhood views 500a and 500b), the locations may be determined based on the locations visible to the user via the GUI 390.

A time period is determined in step 1004. In some instances, the time period may be input by the user (as described above, for example, with reference to the points of interest view 100, the neighborhood views 500a and 500b, and the query module 720). The default time period may be a time period that includes the current time. For example, the default time period may be a time period beginning at the current time and extending into the near future as described above with reference to the street level view 400, the travel route view 600, the crime alert module 710. In another example, the default time period may be a time period ending at the current time and extending into the recent past as described above with reference to the hourly crime forecast module 810 and the daily crime forecast module 820.

In some instances, the crime forecasting system 200 outputs a crime forecast for all crimes. In other instances, the crime forecasting system 200 outputs a crime forecast for a limited subset of crimes. In those instances, one or more crime types are determined in step 1006. A crime type may be a specific offense (e.g., assault, burglary, robbery, etc.). The crime type may also be defined by the seriousness of the offense (e.g., felony, misdemeanor, etc.) or the severity of the offense. The crime type may also be defined by whether the crime was a property crime, an offense against a person, etc. For a property crime, the crime type may be defined by the type of property (a vehicle, a residence, a business, a specific type of business such as retail store, etc.). For each offense against a person, the crime type may be defined by whether the victim knew the assailant or whether the assailant was a stranger and/or demographic information regarding the victim (e.g., age, sex, race, Hispanic origin, economic status, etc.). The crime type(s) may be specified by the user. The crime type(s) may be selected by the crime forecasting system 200 based on the type of crime forecast being determined. For example, the crime forecasting system 200 may select the crime type(s) relevant to an individual traveler (e.g., personal crimes where the victim does not know the perpetrator, auto theft, etc.) when the crime forecasting system 200 is determining a crime forecast to be output via the travel route view 600.

An historical crime rate is determined in step 1008 for each of the locations determined in step 1002. An historical crime rate is determined based on instances in the crime data 322 for a location determined in step 1002 during time periods similar to the time period determined in step 1004 (e.g., the same time of day, the same day of the week, the same season of the year, etc.) for each of the crime types determined in step 1006 (unless no crime type is specified by the user).

A crime forecast is determined in step 1010 for each location determined in step 1002. The crime forecast may be equal to the historical crime rate determined in step 1008. Additionally or alternatively, the crime forecasting system 200 may determine the crime forecast by adjusting the historical crime rate determined in step 1008 based on upcoming events included in the event data 324 and/or weather forecasts in the weather data 328. The crime forecasting system 200 may adjust the crime forecast based on the event data 324 by determining whether the event data 324 includes any events for the locations determined in step 1002 during the time period determined in step 1004, determining whether the type of events included in the event data 324 are correlated with the crime data 322 as described above, and adjusting the crime forecast based on the correlation, if any, between the type of events included in the event data 324 and the crime data 322. Similarly, the crime forecasting system 200 may adjust the crime forecast based on the weather data 328 by determining the weather forecast for the locations determined in step 1002 during the time period determined in step 1004, determining whether the forecasted weather conditions are correlated with the crime data 322 as described above, and adjusting the crime forecast based on the correlation, if any, between the weather conditions and the crime data 322.

A crime forecast is output in step 1012 for each location determined in step 1002.

The crime forecasting system 200 provides benefits for law enforcement agencies. For example, the street view 400 and the neighborhood views 500a and 500b provide information that may allow law enforcement agencies to accurately and effectively deploy resources. In another example, a law enforcement officer may be equipped with a mobile computer system 260 (for example, an intelligent data portal (IDP) manufactured by Motorola Solutions) that may be configured to output some of all of the features described above. Accordingly, the law enforcement officer may be provided with real-time crime forecasting for locations proximate the mobile computer system 260.

The crime forecasting system 200 provides benefits for individuals. For example, the crime forecasting system 200 allows individuals to select a safe travel route (as shown, for example, by the travel route view 600). In another example, the crime forecasting system 200 allows individuals to increase their situational awareness by outputting crime alerts (as shown, for example, by the crime alert module 710 and the MinuteCast® modules 910 and 920). The crime forecasts may be tailored by the crime forecasting system 200 for a particular user. For example, the analysis unit 380 may determine the likelihood of a crime occurring against an individual of the user's demographic group.

The crime forecasting system 200 also provides benefits for business owners. For example, the crime forecasting system 200 allows business owners to anticipate the risk of crimes (e.g., retail theft, property crimes) at business locations (as shown, for example, by the query module 720). In another example, a business owner deciding whether to remain open during an upcoming event may use the crime forecasting system 200 to determine whether there is an increased risk of crime during the event.

While preferred embodiments have been set forth above, those skilled in the art who have reviewed the present disclosure will readily appreciate that other embodiments can be realized within the scope of the invention. For example, disclosures of specific numbers of hardware components, software modules and the like are illustrative rather than limiting. Therefore, the present invention should be construed as limited only by the appended claims.

What is claimed is:

1. A computer implemented-method for determining and outputting a crime forecast, the method comprising:
storing crime data in a database, the crime data including information indicative of the locations and times of crimes;
storing weather data in the database, the weather data including past and forecasted weather conditions;
determining a crime forecast location;
determining a crime forecast time period;
determining, based on the weather data, a forecasted weather condition for the crime forecast location during the crime forecast time period;
determining, based on the crime data and the past weather conditions included in the weather data, a correlation between the crimes included in the crime data and the forecasted weather condition;
determining, based on the crime data, an historical crime rate in the crime forecast location for time periods similar to the crime forecast time period;
determining the crime forecast by adjusting the historical crime rate based on the correlation between the crimes included in the crime data and the forecasted weather condition; and
outputting the crime forecast to a remote computer system.

2. The method of claim 1, wherein the time periods similar to the crime forecast time period are time periods that are the same time of day as the crime forecast time period.

3. The method of claim 1, further comprising:
storing event data in the database, the event data including past events and future events;
determining, based on the event data, a future event in the crime forecast location during the crime forecast time period; and
determining, based on the crime data and the past events included in the event data, a correlation between the crimes included in the crime data and past events,
wherein the crime forecast is determined by further adjusting the historical crime rate based on the correlation between the crimes included in the crime data and the future event.

4. The method of claim 1, wherein:
the crime data further includes information indicative of the types of crimes;
the method further comprises determining a crime type;
the correlation between the crimes included in the crime data and the forecasted weather condition is determined based on a correlation between the crimes that belong to the crime type and the forecasted weather condition;
the historical crime rate is determined based on the historical crime rate for crimes that belong to the crime type in the crime forecast location for time periods similar to the crime forecast time period;
the crime forecast is determined by adjusting the historical crime rate based on the correlation between the crimes that belong to the crime type and the forecasted weather condition.

5. The method of claim 3, wherein the crime type is input by the user.

6. The method of claim 3, wherein the crime type is selected determined based on the demographics of a user.

7. The method of claim 1, wherein the crime forecast time period is specified by a user.

8. The method of claim 1, wherein the crime forecast time period is determined based on the current time.

9. The method of claim 1, wherein the crime forecast location is identified by a user.

10. The method of claim 1, wherein the crime forecast location is selected based on a location of the remote computer system.

11. A crime forecast system, comprising:
a database that stores crime data and weather data, the crime data including information indicative of the locations and times of crimes and the weather data including past and forecasted weather conditions; and
an analysis unit that:
determines a crime forecast location;
determines a crime forecast time period;
determines, based on the weather data, a forecasted weather condition for the crime forecast location during the crime forecast time period;
determines, based on the crime data and the past weather conditions included in the weather data, a correlation between the crimes included in the crime data and the forecasted weather condition;
determines, based on the crime data, an historical crime rate in the crime forecast location for time periods similar to the crime forecast time period;
determines the crime forecast by adjusting the historical crime rate based on the correlation between the crimes included in the crime data and the forecasted weather condition; and
outputs the crime forecast to a remote computer system.

12. The system of claim 11, wherein the time periods similar to the crime forecast time period are time periods that are the same time of day as the crime forecast time period.

13. The system of claim 11, wherein:
the database stores event data including past events and future events; and
the analysis unit:
determines, based on the event data, a future event in the crime forecast location during the crime forecast time period; and
determines, based on the crime data and the past events included in the event data, a correlation between the crimes included in the crime data and past events, and
the crime forecast is determined by further adjusting the historical crime rate based on the correlation between the crimes included in the crime data and the future event.

14. The system of claim 11, wherein:
the crime data further includes information indicative of the types of crimes;
the method further comprises determining a crime type;
the correlation between the crimes included in the crime data and the forecasted weather condition is determined based on a correlation between the crimes that belong to the crime type and the forecasted weather condition;
the historical crime rate is determined based on the historical crime rate for crimes that belong to the crime type in the crime forecast location for time periods similar to the crime forecast time period; and
the crime forecast is determined by adjusting the historical crime rate based on the correlation between the crimes that belong to the crime type and the forecasted weather condition.

15. The system of claim 13, wherein the crime type is input by the user.

16. The system of claim 13, wherein the crime type is selected determined based on the demographics of a user.

17. The system of claim 11, wherein the crime forecast time period is specified by a user.

18. The system of claim 11, wherein the crime forecast time period is determined based on the current time.

19. The system of claim 11, wherein the crime forecast location is identified by a user.

20. The system of claim 11, wherein the crime forecast location is selected based on a location of the remote computer system.
